(19) United States
(12) Patent Application Publication
(10) Pub. No.: US 2026/0369898 A1
(43) Pub. Date: Nov. 19, 2026

(54) QUADRAX ELECTRICAL CABLE WITH WAFER INSULATION DISPLACEMENT CONTACT CONNECTION

(71) Applicant: Amphenol Canada Corporation, Markham (CA)

(72) Inventors: Zlatan LJUBIJANKIC, Mississauga (CA); Peter Ervin JAY, Toronto (CA); Ghanshyam PATEL, Brampton (CA); Barbara Heather MARTEN, Toronto (CA); Karen Anne GIBSON, North York (CA); Antonio CONDELLO, Woodbridge (CA)

(21) Appl. No.: 19/148,393

(22) PCT Filed: Jan. 19, 2024
(86) PCT No.: PCT/IB2024/050535

§ 371 Date: Jul. 16, 2025

Related U.S. Application Data
(60) Provisional application No. 63/480,753, filed on Jan. 20, 2023.

(51) Int. Cl. H01R 4/2429; H01R 43/01

(52) U.S. Cl. CPC H01R 4/2429; H01R 43/01

(57) ABSTRACT

An electrical cable assembly includes a cable containing electrically conductive wires, a connector housing defining an internal area, an insulation displacement contact (IDC) wafer adapter assembly disposed in the internal area of the connector housing, and a plurality of IDC wafers disposed in the IDC wafer adapter assembly. The connector housing has a mating interface end defining a mating interface opening and an opposing cable interface end defining a cable interface opening configured to receive the cable. The IDC wafer adapter assembly is disposed in the internal area of the connector housing and organizes the electrically conductive wires into a quadrax arrangement. The IDC wafers are configured to establish IDC connections with the electrically conductive wires such that the number of IDC connections match the number of the IDC wafers.

### CROSS REFERENCE TO RELATED APPLICATIONS

This application claims the benefit of U.S. Application No. 63/480,753, filed on Jan. 20, 2023, which is incorporated herein by reference in its entirety.

### BACKGROUND

High speed electrical connectors transmit high speed signals at low losses. Such high speed electrical connectors may be used for transmitting and receiving various types of data, for example, related to defense and commercial applications. In certain applications, these high speed electrical connectors mount to a printed circuit board and establish electrical connection with the circuit traces thereof. The machining of these high speed data connectors, however, can be costly and time consuming, particularly due to the high cycle time.

### SUMMARY

According to a non-limiting embodiment, an electrical cable assembly includes a cable containing electrically conductive wires, a connector housing defining an internal area, an insulation displacement contact (IDC) wafer adapter assembly disposed in the internal area of the connector housing, and a plurality of IDC wafers disposed in the IDC wafer adapter assembly. The connector housing has a mating interface end defining a mating interface opening and an opposing cable interface end defining a cable interface opening configured to receive the cable. The IDC wafer adapter assembly is disposed in the internal area of the connector housing and organizes the electrically conductive wires into a quadrax arrangement. The IDC wafers are configured to establish IDC connections with the electrically conductive wires such that the number of IDC connections match the number of the IDC wafers

In addition to one or more of the features described above, or as an alternative, in further embodiments the electrical cable assembly further includes a tail end assembly configured to detachably couple to the electrical connector.

In addition to one or more of the features described above, or as an alternative, in further embodiments the electrically conductive wires of the electrical cable comprise a first differential wire pair and a second differential wire pair, wherein the IDC wafer adapter assembly disposes on a first axis the first differential wire pair with a first wire and a second wire, and wherein the IDC wafer adapter assembly disposes on a second axis the second differential wire pair with a third wire and an opposing fourth wire, wherein the first axis is perpendicular to the second axis

In addition to one or more of the features described above, or as an alternative, in further embodiments the electrical cable assembly further includes a front connector detachably coupled to the IDC wafer adapter assembly. The front connector includes a plurality of front contacts extending through the hollow internal area of the connector housing and being exposed via the mating interface opening.

In addition to one or more of the features described above, or as an alternative, in further embodiments the plurality of IDC wafers each include an IDC connection assembly that establishes a physical IDC connection with the electrically conductive wires of the electrically conductive wires.

In addition to one or more of the features described above, or as an alternative, in further embodiments the electrical cable assembly further includes the IDC connection assembly includes an electrically conductive connector pin, an electrically conductive terminal having a first end coupled to the connector pin, and an electrically conductive blade coupled to an opposing second end of the electrically conductive terminal, the electrically conductive blade directly contacting an electrically conductive wire of the plurality of electrically conductive wires.

In addition to one or more of the features described above, or as an alternative, in further embodiments, at least one of the electrically conductive connector pin, the electrically conductive terminals, and the electrically conductive blade is stamped from an electrically conductive material.

In addition to one or more of the features described above, or as an alternative, in further embodiments, at least one of the electrically conductive connector pin, the electrically conductive terminals, and the electrically conductive blade is overmolded with a polymer material.

In addition to one or more of the features described above, or as an alternative, in further embodiments the IDC wafers include a first pair of differential IDC wafers including a first IDC wafer establishing a first IDC connection with the first wire and a second IDC wafer establishing a second IDC connection with the second wire; and a second pair of differential IDC wafers including a third IDC wafer establishing a third IDC connection with the third wire and a fourth IDC wafer establishing an IDC connection with the fourth wire.

In addition to one or more of the features described above, or as an alternative, in further embodiments, the wire organizer includes a plurality of guide trenches that each receive one of the plurality of electrically conducive wires, and are spaced apart from one another to define a plurality of wafer spaces that each receive one of the plurality of IDC wafers.

In addition to one or more of the features described above, or as an alternative, in further embodiments, the wire organizer includes a plurality of braces disposed in the plurality of wafer spaces, respectively, each of the braces including an IDC slot that receive the electrically conductive blades, respectively.

In addition to one or more of the features described above, or as an alternative, in further embodiments, the plurality of braces includes a first differential brace pair with a first brace disposed in the first wafer space and a second brace disposed in the second wafer space; and a second differential brace pair with a third brace disposed in the third wafer space and a fourth brace disposed in the fourth wafer space.

In addition to one or more of the features described above, or as an alternative, in further embodiments, the electrically conductive blade of the first IDC wafer is disposed in the IDC slot of the first brace, the electrically conductive blade of the second IDC wafer is disposed in the IDC slot of the second brace, the electrically conductive blade of the third IDC wafer is disposed in the IDC slot of the third brace, and the electrically conductive blade of the fourth IDC wafer is disposed in the IDC slot of the fourth brace.

In addition to one or more of the features described above, or as an alternative, in further embodiments the electrical cable assembly further includes a coupling assembly that couples together the electrical cable and the IDC wafer adapter assembly.

In addition to one or more of the features described above, or as an alternative, in further embodiments, the coupling assembly includes a first mating portion coupled to the electrical cable and a second mating portion coupled to the IDC wafer adapter assembly.

In addition to one or more of the features described above, or as an alternative, in further embodiments, the first mating portion includes a bushing coupled to the cable, and wherein the second mating portion includes a ferrule assembly coupled to the bushing and the connector housing.

In addition to one or more of the features described above, or as an alternative, in further embodiments, the bushing includes a bushing body having bushing threads formed thereon, and wherein an inner surface of the connector housing has a connector threads that mate with bushing threads to couple together the connector housing and the tail end assembly.

In addition to one or more of the features described above, or as an alternative, in further embodiments, the ferrule assembly includes a rear ferrule coupled to the bushing, and a front ferrule coupled to the rear ferrule and the IDC wafer adapter assembly.

According to another non-limiting embodiment, a quadrax insulation displacement contact (IDC) wafer adapter assembly includes a plurality of IDC wafers and a wire organizer. The plurality of insulation displacement contact (IDC) wafers each include an electrically conductive IDC connection assembly configured to establish an IDC connection with an electrically conductive wire among a plurality of electrically conductive wires. The wire organizer extends along a center axis to define an assembly length, and is configured to receive a plurality of wires and to receive the plurality of IDC wafers such that IDC connection assembly of the IDC wafers physically contact the plurality of wires respectively to establish a full-symmetry connection.

In addition to one or more of the features described above, or as an alternative, in further embodiments, the wire organizer disposes the electrically conductive wires into a quadrax arrangement which includes a plurality of differential wire pairs, and wherein the full-symmetry connection is established among the differential wire pairs such that contacts included with the conductive IDC connection assembly are arranged in a differential pair that are equidistant from center axis, extending through the wire organizer, throughout the entire assembly length.

In addition to one or more of the features described above, or as an alternative, in further embodiments, the plurality of differential wire pairs includes a first differential wire pair with a first wire and a second wire arranged along a first axis, and a second differential wire pair with a third wire and a fourth wire arranged along a second axis, wherein the second axis extends perpendicular to the first axis.

In addition to one or more of the features described above, or as an alternative, in further embodiments, the electrically conductive IDC connection assembly includes an electrically conductive connector pin, an electrically conductive terminal having a first end coupled to the connector pin, and an electrically conductive blade coupled to an opposing second end of the electrically conductive terminal. The electrically conductive blade is configured to directly contact a respective wire of the plurality of electrically conductive wires and establish electrical connection between the electrically conductive wire and the connector pin.

According to still another non-limiting embodiment, a method of servicing an electrical cable assembly is provided. The method includes decoupling an electrical connector from a tail end assembly, and removing a portion of the tail end assembly from within the electrical connector. The portion of the tail end includes an insulation displacement contact (IDC) wafer adapter assembly coupled to the tail end assembly and a front contact detachably coupled to the IDC wafer adapter assembly.

In addition to one or more of the features described above, or as an alternative, in further embodiments, the method further includes removing the front contact assembly from the IDC wafer adapter assembly, and coupling another front contact assembly to the IDC wafer adapter assembly.

In addition to one or more of the features described above, or as an alternative, in further embodiments, the method further includes inserting the portion of the tail end assembly into the electrical connector, and coupling the electrical connector from the tail end assembly.

In addition to one or more of the features described above, or as an alternative, in further embodiments, removing the front contact assembly includes clips that secure connector pins coupled to the IDC wafer adapter assembly, and wherein removing the front contact assembly from the IDC wafer adapter assembly includes removing the connector pins from the clips.

In addition to one or more of the features described above, or as an alternative, in further embodiments, coupling the another front contact assembly to the IDC wafer adapter assembly includes inserting the connector pins into the IDC wafer adapter such that the clips secure connector pins.

According to yet another non-limiting embodiment, a method is provided for manufacturing an electrical cable assembly. The method comprises inserting electrically conductive wires of a cable into a wire organizer that defines an internal area such that the electrically conductive wires are organized into a quadrax arrangement. The method further comprises disposing a plurality of insulation displacement contact (IDC) wafers in the internal area of the wire organizer to provide a IDC wafer adapter that establishes IDC connections with the electrically conductive wires. A number of the IDC connections match a number of the IDC wafers. The method further comprises inserting the IDC wafer adapter into an internal area of a connector housing, and coupling the connector housing to the cable.

In addition to one or more of the features described above, or as an alternative, in further embodiments, the method includes organizing the electrically conductive wires into the quadrax arrangement includes disposing on a first axis a first differential wire pair and disposing on a second axis a second differential wire pair, where the second axis being perpendicular with respect to the first axis.

In addition to one or more of the features described above, or as an alternative, in further embodiments, coupling the connector housing to the cable comprises detachably coupling a first end of the IDC wafer adapter to a front contact assembly; coupling a first end of a coupling assembly to a second end of the IDC wafer adapter and coupling a second end of the coupling assembly to the cable; and detachably coupling the connector housing to the coupling assembly.

In addition to one or more of the features described above, or as an alternative, in further embodiments, the front contact assembly includes a plurality of electrically conductive front contacts. Coupling the front contact assembly to the IDC wafer adapter establishes electrical conductivity between the electrically conductive front contacts and the electrically conductive wires.

Additional technical features and benefits are realized through the techniques of the present disclosure. Embodiments and aspects of the present disclosure are described in detail herein. For a better understanding, refer to the detailed description and to the drawings.

### BRIEF DESCRIPTION OF THE DRAWINGS

The foregoing and other features of the embodiments are apparent from the following detailed description taken in conjunction with the accompanying drawings in which:

FIG. 1A is a perspective view of an electrical cable assembly according to a non-limiting embodiment of the present disclosure;

FIG. 1B is a disassembled view of the electrical cable assembly shown in FIG. 1A according to a non-limiting embodiment of the present disclosure;

FIG. 1C is a cross-sectional view taken along line 1-1 of a front connector included in the electrical cable assembly shown in FIG. 1B according to a non-limiting embodiment of the present disclosure;

FIG. 2A is a perspective view of a tail end assembly included in the electrical cable assembly shown in FIG. 1B according to a non-limiting embodiment of the present disclosure;

FIG. 2B is a cross-sectional view of the tail end assembly shown in FIG. 2A taken along line 2-2 according to a non-limiting embodiment of the present disclosure;

FIG. 3 illustrates a process diagram for assembling a coupling assembly included in the tail end assembly shown in FIG. 2A according to a non-limiting embodiment of the present disclosure;

FIG. 4A is a schematic view of an assembled IDC wafer adapter assembly according to a non-limiting embodiment of the present disclosure;

FIG. 4B is a cross-sectional view of the IDC wafer adapter assembly shown in FIG. 4A taken along line 3-3 according to a non-limiting embodiment of the present disclosure;

FIG. 4C is a cross-sectional view of the IDC wafer adapter assembly shown in FIG. 4A taken along line 4-4 according to a non-limiting embodiment of the present disclosure;

FIG. 4D is a disassembled view of the IDC wafer adapter assembly shown in FIG. 4A according to a non-limiting embodiment of the present disclosure;

FIG. 4E is a pre-assembled view of a wire organizer included in the IDC wafer adapter assembly shown in FIG. 4D according to a non-limiting embodiment of the present disclosure;

FIG. 4F depicts the wire organizer shown in FIG. 4E with an adapter plug removed from the wire organizer according to a non-limiting embodiment of the present disclosure;

FIG. 4G is a cross-sectional view of the wire organizer shown in FIG. 4E taken along line 5-5 according to a non-limiting embodiment of the present disclosure;

FIG. 4H is a rear view of the wire organizer shown in FIG. 4E according to a non-limiting embodiment of the present disclosure;

FIG. 4I depicts an IDC wafer according to a non-limiting embodiment of the present disclosure;

FIGS. 5A through 5C are a series of drawings illustrating a process diagram for assembling an IDC wafer adapter assembly with respective wires, where:

FIG. 5A illustrates a disassembled IDC wafer adapter assembly with a plurality of wires inserted in the wire organizer to provide first and second differential wire pairs according to a non-limiting embodiment of the present disclosure;

FIG. 5B illustrates the IDC wafer adapter assembly shown in FIG. 5A following insertion of a first differential IDC wafer pair to establish electrical connection with a first differential wire pair according to a non-limiting embodiment of the present disclosure; and

FIG. 5C illustrates the IDC wafer adapter assembly shown in FIG. 5B following insertion of a second differential IDC wafer pair to establish electrical connection with a second differential wire pair according to a non-limiting embodiment of the present disclosure.

FIG. 6A is a disassembled view of an IDC wafer adapter assembly according to a non-limiting embodiment of the present disclosure; and

FIG. 6B is a perspective view of the IDC wafer adapter assembly shown if FIG. 6A according to a non-limiting embodiment of the present disclosure.

FIGS. 7A through 7D are a series of drawings illustrating a process diagram for assembling the electrical cable assembly shown in FIG. 1A, where:

FIG. 7A depicts the electrical cable assembly after coupling the tail end assembly to the wire organizer according to a non-limiting embodiment of the present disclosure;

FIG. 7B depicts the electrical cable assembly of FIG. 7A following insertion of the IDC wafers in the wire organizer to establish electrical connection with a plurality of wires according to a non-limiting embodiment of the present disclosure;

FIG. 7C depicts the electrical cable assembly of FIG. 7B after coupling the assembled IDC wafer adapter assembly to a front connector according to a non-limiting embodiment of the present disclosure; and

FIG. 7D depicts the electrical cable assembly of FIG. 7C after inserting the assembled IDC wafer adapter assembly into a connector housing and coupling the connector housing to the tail end assembly according to a non-limiting embodiment of the present disclosure.

FIGS. 8A through 8D are a series of drawings illustrating a process diagram for fabricating a pair of IDC wafers, where:

FIG. 8A depicts a pair of electrical terminals having a first end coupled to a contact and an opposing second end coupled to a blade following a metal stamping process according to a non-limiting embodiment of the present disclosure;

FIG. 8B depicts the contacts shown in FIG. 8A following a metal plating process according to a non-limiting embodiment of the present disclosure;

FIG. 8C depicts the pair of electrical terminals shown in FIG. 8B following an over-molding process to form a pair of IDC wafers according to a non-limiting embodiment of the present disclosure;

FIG. 8D depicts the pair of IDC wafers shown in FIG. 8C after cutting a carrier strip to separate a first IDC wafer from a second IDC wafer according to a non-limiting embodiment of the present disclosure; and

FIG. 8E depicts the first IDC wafer having a first length and the second IDC wafer having a second length greater than the first length according to a non-limiting embodiment of the present disclosure and carrier strip being removed form first and second IDC wafer.

The diagrams depicted herein are illustrative. There can be many variations to the diagrams or the operations described therein without departing from the spirit of the disclosure. For instance, the actions can be performed in a differing order or actions can be added, deleted or modified. Also, the term “coupled” and variations thereof describes having a communications path between two elements and may include a direct connection between the elements with no intervening elements or connections between them or an indirect connection with, for example, one or more intervening elements or connections. All of these variations are considered a part of the specification. It should also be appreciated that that features from one embodiment can be combined with features from one or more other embodiments described herein.

In the accompanying figures and following detailed description, the various elements illustrated in the figures are provided with two or three digit reference numbers.

### DETAILED DESCRIPTION

Various embodiments are described herein with reference to the related drawings. Alternative embodiments can be devised without departing from the scope of this disclosure. Various connections and positional relationships (e.g., over, below, adjacent, first direction, second direction, etc.) are set forth between elements in the following description and in the drawings. These connections and/or positional relationships, unless specified otherwise, can be direct or indirect, and the disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “includes,” “comprising,” “includes,” “including,” “has,” “having,” “contains” or “containing,” or any other variation thereof, are intended to cover a non-exclusive inclusion. For example, a composition, a mixture, process, method, article, or apparatus that includes a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” The various non-limiting embodiments or designs described herein are “exemplary” and not necessarily to be construed as preferred or advantageous over other embodiments or designs. The terms “at least one” and “one or more” include any number greater than or equal to one, e.g., one, two, three, four, etc. The terms “a plurality” include any number greater than or equal to two, e.g., two, three, four, five, etc. The term “connection” includes both an indirect connection and a direct connection.

The terms “about,” “substantially,” “approximately,” and variations thereof, are intended to include the degree of error associated with measurement of the particular quantity based upon the equipment available at the time of filing the application.

Turning now to an overview of technologies relevant to aspects of the disclosure, traditionally quadrax connectors may employ differential machined contact pairs where each machined contact included in a respective differential pair is arranged diagonally opposite from one another. Fabrication methods used to establish the differential contact pairs involve stamping one or more of the contacts, crimping the contacts to the wires, overmolding a dielectric wafer body around and over the contacts and leaving the contact tail ends uncovered, cutting and removing the carrier strip from the overmolded wafer body, inserting the crimped wires into a ferrule and inserting the ferrule into a connector shell, and crimping the connector shell to the ferrule. The overmolding process, however, may permanently fix the contacts and the wires within the dielectric wafer body. In addition, the connector crimping process may permanently fix the ferrule to the connector shell and deform the connector shell. Should one or more of the contacts be damaged, the entire cable assembly may need to be replaced.

One or more non-limiting embodiments as discussed herein provides an electrical cable assembly that implements an insulation displacement contact (IDC) connection. The cable assembly includes an electrical connector, an IDC wafer adapter assembly, and a tail end assembly. The IDC wafer adapter assembly utilizes a wire organizer that places a plurality of wires bundled in the tail end assembly into a quadrax arrangement that provides full-symmetry connection between the differential contact pairs of the quadrax arrangement. A full-symmetry connection is defined, for example, as disposing contacts within a differential pair that are equidistant from center axis throughout the entire length of the connector assembly. The wire organizer receives a plurality of individual IDC wafers having IDC contacts that establish the IDC connection with a respective wire. The electrical connector is detachably coupled to the IDC wafer adapter assembly and the tail end. Via this detachability, it is not necessary to replace the entire electrical cable assemble should one or more of front contacts be damaged.

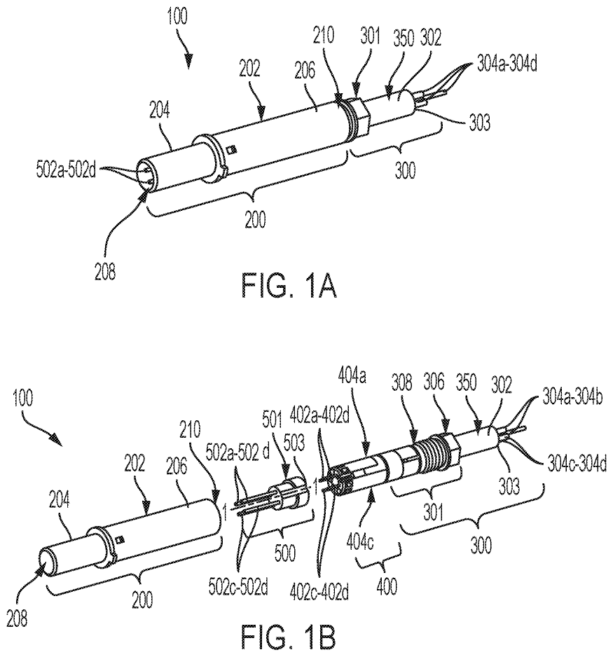

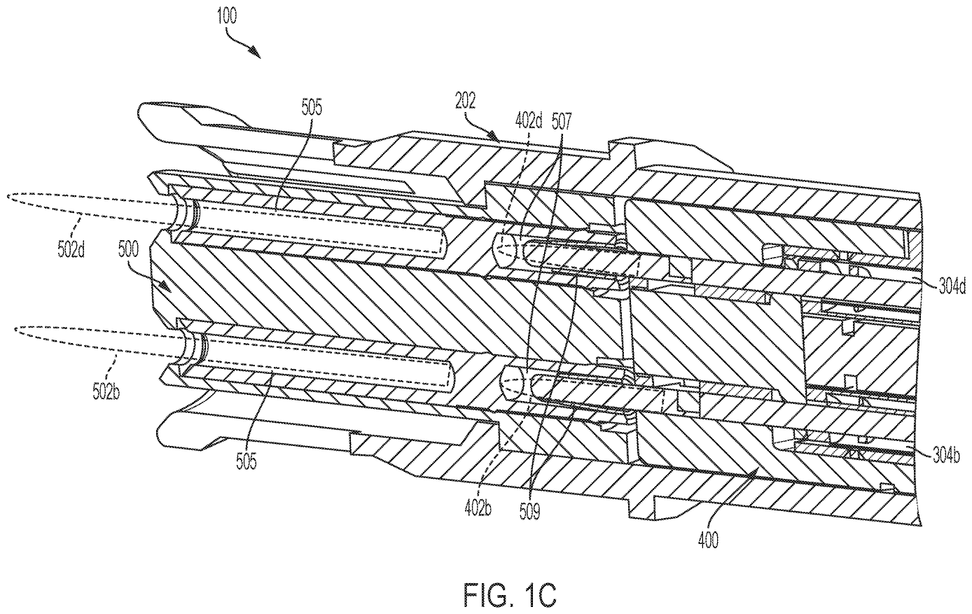

With reference now to FIGS. 1A and 1B, an electrical cable assembly 100 is illustrated according to a non-limiting embodiment of the present disclosure. FIG. 1A is a perspective view illustrating exterior components of the electrical cable assembly 100 including an electrical connector and an exterior portion of a tail end assembly 300 including a cable 350. FIG. 1B is a disassembled view illustrating the exterior components, along with various internal components of the electrical cable assembly 100 including a front contact assembly 500 detachably couplable to an IDC wafer adapter assembly 400, and a coupling assembly 301 allowing coupling of the IDC wafer adapter assembly 400 to the tail end assembly 300.

The electrical connector 200 includes a connector housing 202. The connector housing 202 is shown having a cylindrical profile, but it should be appreciated the connector housing 202 can have other profile shapes (e.g., a box-shaped profile) without departing from the scope of the invention. The connector housing 202 extends from a mating interface end 204 to a cable interface end 206, the mating interface end 204 defining a mating interface opening 208, and the cable interface end 206 defining a cable interface opening 210. The cable interface opening 210 is configured to receive the front contact assembly 500, the IDC wafer adapter assembly 400, and a portion of the tail assembly 300 (e.g., the coupling assembly).

The cable interface end 206 is configured to be detachably coupled to the tail end assembly 300. In one or more non-limiting embodiments, the cable interface end 206 includes connector threads formed on an inner surface thereof. The connector threads are configured to mate with threads formed on the coupling assembly 301. In this manner, the connector housing 202 can be screwed (e.g., coupled) and unscrewed (decoupled) from the tail end assembly 300. Although at least one non-limiting embodiment of the present disclosure describes a threaded connection as the mechanism to facilitate the coupling and decoupling of the connector housing 202 and the tail end assembly 300, it should be appreciated that other techniques can be implemented to coupling/decoupling mechanism including, but not limited to, press fitting together connector housing 202 and the tail end assembly 300, a clip and hook assembly that fastens and unfastens connector housing 202 and the tail end assembly 300, etc.

The cable 350 is coupled to one end of the coupling assembly 301. The cable 350 includes a cable sheath 302 and an inner cable braid 303. The cable sheath 302 bundles together a plurality of electrically conductive wires 304a, 304b, 304c and 304d (collectively referred to as 304a-304d). Each of the electrically conductive wires 304a-304d includes an insulative layer which electrically insulates each of the electrically conductive wires 304a-304d from one another. The inner cable braid 303 shields the plurality of electrically conductive wires 304a-304d from electrical crosstalk noise and/or electromagnetic (EM) interference.

The coupling assembly 301 is configured to couple together the cable 350 and the IDC wafer adapter assembly 400. The coupling assembly 301 includes a first mating portion 306 coupled to the cable 350 and a second mating portion 308 coupled to the IDC wafer adapter assembly 400. Accordingly, coupling the first mating portion 306 to the second mating portion 308 couples together the cable 350 and the IDC wafer adapter assembly 400.

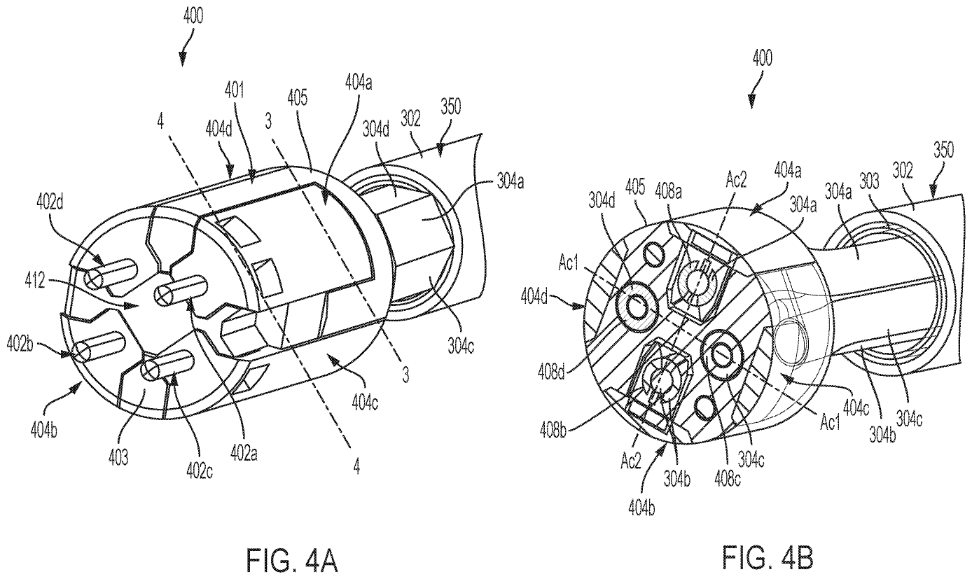

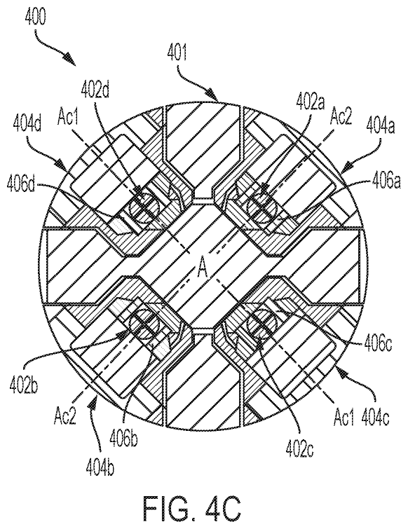

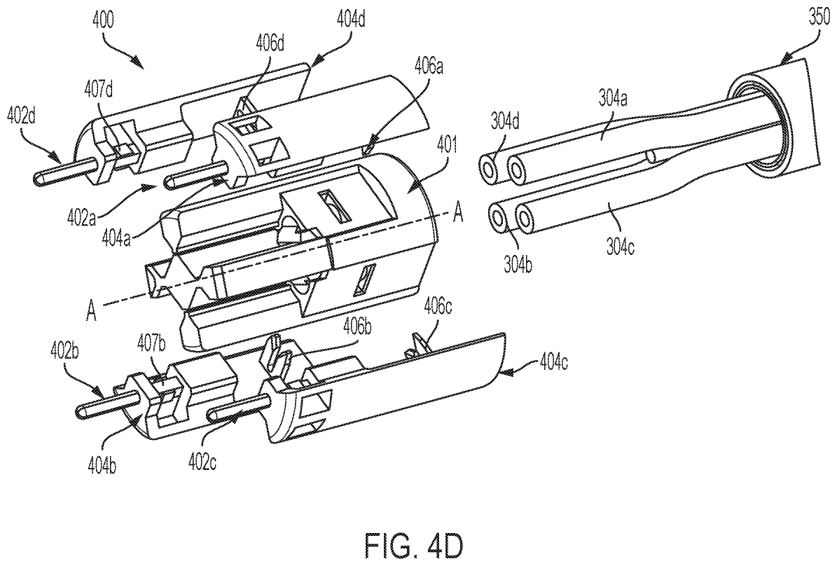

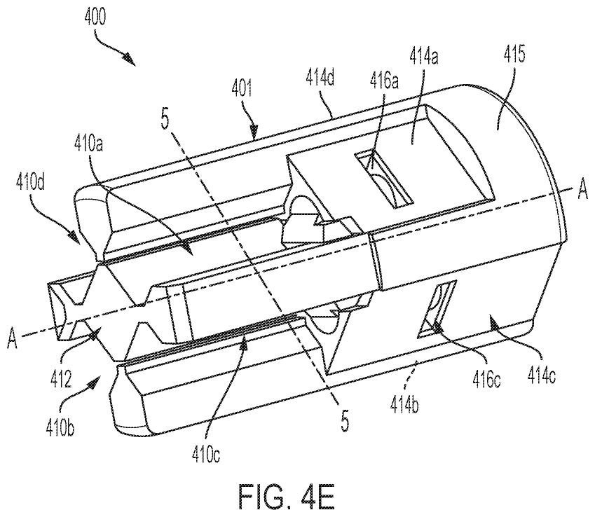

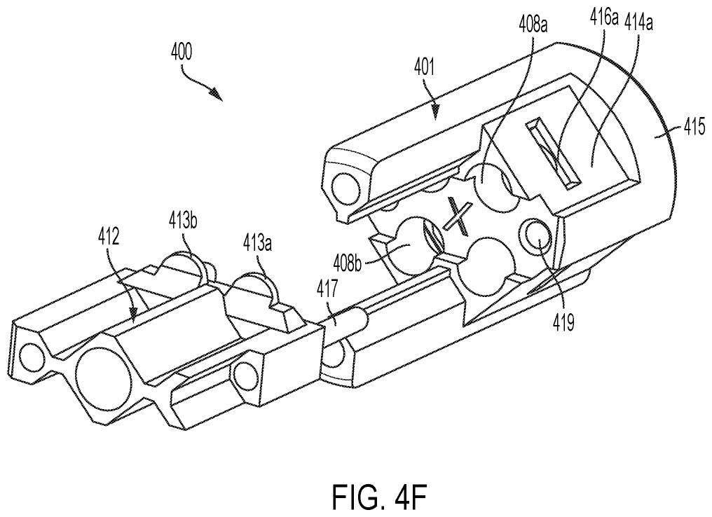

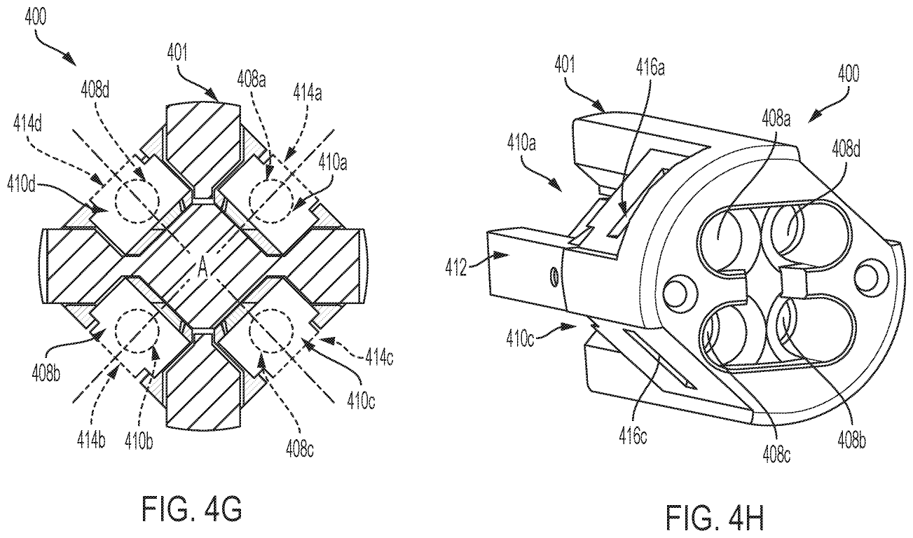

The IDC wafer adapter assembly 400 includes a plurality of IDC wafers 404a, 404b, 404c, and 404d (collectively referred to as IDC wafers 404a-404d—see FIG. 4A). Each of the IDC wafers 404a-404d establishes an IDC connection with a respective wire 304a-304d, which in turn establishes electrical conductivity between a wire 304a-304d and a respective connector pin 402a-402d formed on an IDC wafer 404a-404d.

The front contact assembly 500 includes a front portion 501 and a rear portion 503. The front portion 501 has a plurality of front contacts 502a, 502b, 502c and 502d (collectively referred to as front contacts 502a-502d). The rear portion 503 is configured to receive the connector pins 402a-402d of the IDC wafer adapter assembly 400 so that each connector pin 402a-402d physically contacts a respective contact 502a-502d. Accordingly, the front contact assembly 500 establishes electrical conductivity between the connector pins 402a-402d and the plurality of contacts 502a-502d.

As described herein, the front contact assembly 500 is inserted into the connector housing 202 and the connector housing 202 is coupled to the tail end assembly 300 so that the front contacts 502a-502d extend through the connector housing 202 and are exposed by the mating interface opening 208. Accordingly, the mating interface end 204 can be connected to a corresponding mating connector (not shown) installed on a separate electrical connector (not shown) or a circuit board (not shown).

Should the front contact assembly 500 and/or one or more of the front contacts 502a-502d be damaged, the electrical connector 200 can be detached from the tail end assembly 300. The damaged front contact assembly 500 can be replaced with a new front contact assembly 500 and the electrical connector 200 can be re-attached to the tail end assembly 300. In this manner, the electrical cable assembly 100 provides a desirable serviceability feature.

FIG. 1C is a cross-sectional view taken along line 2-2 of the front contact assembly 500 included in the electrical cable assembly 100 shown in FIG. 1B. The front contact assembly 500 includes front sockets 505 and rear openings 507. Each of the front sockets 505 support a respective front contact 502a-502d disposed therein. Each of the rear openings 507 are configured to receive a respective connector pin 402a-402d that can be insertable therein. In one or more non-limiting embodiments, the front contact assembly 500 can include a clip 509 disposed in a respective rear opening 507. The clip 509 can be spring load or elastically biased to press against a connector pin 402a-402d inserted in a respective rear opening 507. Accordingly, the clips 509 can secure the connector pins 402a-402d disposed in the rear openings 507 when the front contact assembly 500 is attached to the IDC wafer adapter assembly 400, while still allowing the front contact assembly 500 to be decoupled from the IDC wafer adapter assembly 400 if necessary, e.g., when servicing the electrical cable assembly 100 as described herein.

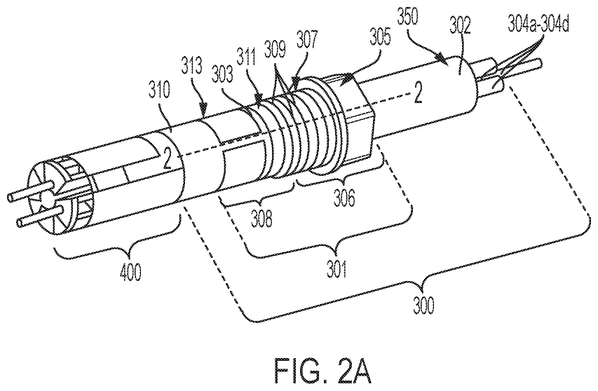

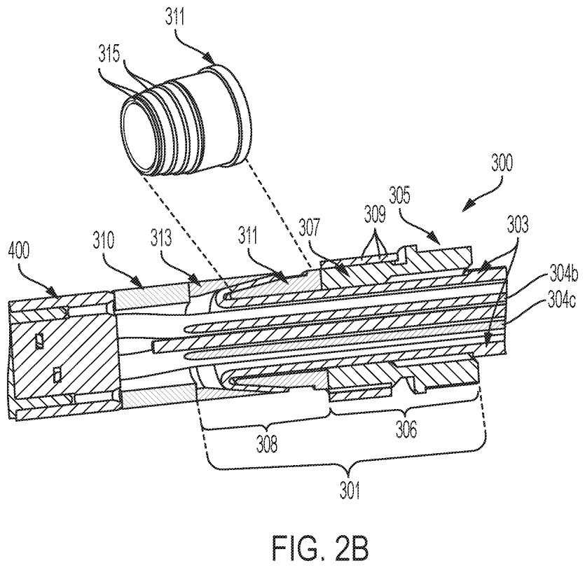

Turning now to FIGS. 2A and 2B, the tail end assembly 300 is illustrated in greater detail. The tail end assembly 300 includes the cable 350, the coupling assembly 301, and a collar 310. As described herein, the coupling assembly 301 includes a first mating portion 306 and a second mating portion 308. According to a non-limiting embodiment, the first mating portion 306 is implemented as a bushing 306 and the second mating portion is implement as a ferrule assembly 308.

The bushing 306 can detachably couple the tail end assembly 300 to the electrical connector 200. The bushing 306 includes a bushing head 305 and a bushing body 307. The bushing head 305 includes an opening which receives the cable sheath 302 and passes the cable sheath therethrough to the hollow bushing body 307. The bushing body 307 has a plurality of bushing threads 309 formed on an outer surface thereof, and may also include a hollow profile capable of passing the cable sheath 302 therethrough to the ferrule assembly 308. The bushing threads 309 mate with the connector threads formed on the inner surface of the cable interface end 206 of the connector housing 202.

The ferrule assembly 308 is configured to couple the bushing 306 to the IDC wafer adapter assembly 400. The ferrule assembly 308 includes a rear ferrule 311 and a front ferrule 313. The rear ferrule 311 is coupled to the bushing body 307 and is configured to receive cable sheath 302. The front ferrule 313 is coupled to the rear ferrule 311 and is configured to pass the wires 304a-304d from the cable sheath 302 to the IDC wafer adapter assembly 400.

The collar 310 can be implemented to further support the coupling between the coupling assembly 301 and the IDC wafer adapter assembly 400. In one or more non-limiting embodiments, the collar 310 can include, but is not limited to, an adhesive or epoxy, which has a first portion coupled to the ferrule assembly 308 (e.g., the front ferrule 313) and a second portion coupled to the IDC wafer adapter assembly 400.

Turning to FIG. 2B, a cross-sectional view of the tail end assembly 300 shown in FIG. 2A taken along line 2-2 is illustrated according to a non-limiting embodiment. As described herein the bushing 306 and the ferrule assembly 308 pass through the cable sheath 302 and convey the wires 304a-304d from the cable 350 to the IDC wafer adapter assembly 400. According to a non-limiting embodiment, the coupling assembly 301 is configured to constrain the cable 350 and inhibit the ability for it to be unintentionally displaced.

According to a non-limiting embodiment, a portion of the cable sheath 302 is removable to expose the braid 303, with the braid 303 then being insertable into the bushing 306 for conveyance past the end of the front ferrule 313. An excess portion of the braid 303 is then folded back over the outer surface of the rear ferrule 311, and the front ferrule 313 is slidable over the outer surface of the rear ferrule 311 such that folded portion of the braid 303 may be wedged or sandwiched in place between an inner surface of the front ferrule 313 and the outer surface of the rear ferrule 311. In one or more non-limiting embodiments, the outer surface of the rear ferrule 311 includes serrations 315 configured to “pierce” into the cable braid 303 and secure against the rear ferrule 311. Coupling the connector housing 202 to the coupling assembly 301 may also apply a tension force onto the cable braid 303, which further constrains the braid 303 in place and prevents displacement of the electrical cable 350 from the coupling assembly 301.

Although FIGS. 2A and 2B describe the first mating portion 306 of the coupling assembly 301 as a bushing 306 and the second mating portion 308 as a ferrule assembly 305, it should be appreciated that other types of coupling assemblies 301 can be employed to couple together the cable 350 and the IDC wafer adapter assembly 400 without departing from the scope of the invention. For example, one or more non-limiting embodiments can implement the first mating portion 306 as a clip or fastener and can implement the second mating portion 308 as a hook or slot configured to mate with the clip or fastener, which when fastened or clipped together couples the cable 350 to the IDC wafer adapter assembly 400.

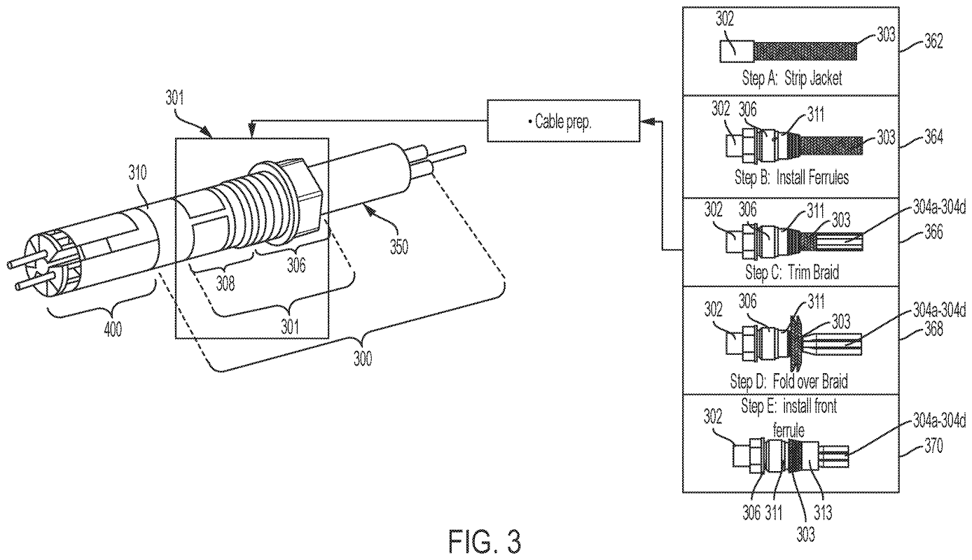

Turning now FIG. 3, a process diagram for preparing the cable 350 for assembly according to a non-limiting embodiment of the present disclosure. The process begins at operation 362, where a portion of the cable sheath is removed (e.g., stripped) to expose a portion of the underlying cable braid 303. At process 364, the rear ferrule 311 and the bushing 306 are coupled to the portion of the braid 303. At process 366, a portion of the uncovered braid 303 is trimmed to expose the wires 304a-304d. At process 368, the remaining portion of the braid 303 is folded over and on top of the outer surface of the rear ferrule 311. At operation 370, the front ferrule 313 is slid over the folded braid 303 and the rear ferrule 311, thereby constraining the braid 303 in place.

Turning now to FIGS. 4A to 4I, an IDC wafer adapter assembly 400 is illustrated according to a non-limiting embodiment of the present disclosure. The IDC wafer adapter assembly 400 includes a wire organizer 401 and a plurality of IDC wafers 404a-404d. The wire organizer 401 extends from a front end 403 to a rear end 405, which includes a plurality of wire holes 408a, 408b, 408c and 408d, collectively referred to as wire slots 408a-408d (see e.g., FIG. 4B). Each of the wires holes 408a-408d receives a corresponding wire 304a-304d. That is, each wire hole 408a-408d receives a respective wire 304a-304 included in the electrical cable 350.

The wire organizer 401 is configured to dispose the electrically conductive wires 304a-304d into a quadrax arrangement (e.g., a plurality of differential wire pairs). According to a non-limiting embodiment, a first differential wire pair includes a first wire 304a and an opposing second wire 304b arranged along a first axis (Ac1), and a second differential wire pair includes a third wire 304c and an opposing fourth wire 304d arranged along a second axis (Ac2) that extends perpendicular with respect to the first axis (Ac1).

As shown in FIG. 4F, the wire organizer 401 includes an insertable adapter plug 412 having stoppers 413a and 413b, which are insertable into correspond wire holes wire holes 408a and 408b, respectively. Accordingly, the stoppers 413a and 413b partially plug the wire holes 408a and 408b to prevent the wires 304a-304d from contacting one another, i.e., short-circuiting. In one or more non-limiting embodiments, the adapter plug 412 can further include one or more guide pins 417, which are insertable into a corresponding pin hole 419 to guide insertion of the adaptable plug 412 into the wire organizer 401.

According to a non-limiting embodiment of the disclosure, the wafer spaces 410a-410d include a first differential wafer space pair (e.g., 410a and 410b) and a second differential wafer space pair (e.g., 410c and 410d). The first differential wafer space pair includes a first differential wafer space 410a configured to receive the first IDC wafer 404a and a second differential wafer space 410b configured to receive the second IDC wafer 404b. Likewise, the second differential wafer space pair includes a third differential wafer space 410c configured to receive the third IDC wafer 404c and a fourth differential wafer space 410d configured to receive the fourth IDC wafer 404d.

The wire organizer 401 may also include a plurality of braces 414a-414d, which are disposed in the wafer spaces 410a-410d, respectively. Each of the braces 414a-414d includes an IDC slot 416a-416d. According to a non-limiting embodiment of the disclosure, the braces 414a-414d include a first differential brace pair (e.g., 414a and 414b) and a second differential brace pair (e.g., 414c and 414d). The first differential brace pair includes a first brace 414a disposed in the first wafer space 410a and a second brace 414b disposed in the second wafer space 410b. The first and second braces 414a and 414b each extends from a first end to an opposing end that contacts a shoulder portion 415 of the wire organizer 401 to define a first brace length. The second differential brace pair includes a third brace 414c disposed in the third wafer space 410c and a fourth brace 414d disposed in the fourth wafer space 410d. The third and fourth braces 414c and 414d each extends from a first end to an opposing end that meets the rear end of the wire organizer 401 to define a second brace length that is greater than the first brace length.

As shown in FIGS. 4A to 4D, each of the IDC wafers 404a-404d establishes an IDC connection with a respective wire 304a-304d disposed in a respective wire slot 408a-408d. Examples of a first IDC wafer 404a (e.g., a short IDC wafer) and a second IDC wafer 404c (e.g., a long IDC wafer) are illustrated in FIG. 4I. Although, IDC wafers 404a and 404c are illustrated, it should be appreciated that IDC wafer 404a can also represent IDC wafer 404b and IDC wafer 404c can represent IDC wafer 404d. Each of the IDC wafers 404a-404d includes an electrically conductive IDC connection assembly to establish a physical IDC connection with a respective wire 304a-304d. According to a non-limiting embodiment, the number of the IDC connections matches the number of the IDC wafers 404a-404d. As shown in FIG. 4D, for example, four individual IDC wafers 404a-404d each establish their own IDC connection with a given respective wire 304a-304d. Accordingly, the four IDC connections match the number of individual IDC wafers 404a-404d. e.g., four IDC wafers 404a-404d.

The IDC connection assembly includes an electrically conductive connector pin 402a-402d, an electrically conductive terminal 407a-407d having a first end coupled to the connector pin 402a-402d, and an electrically conductive blade 406a-406d coupled to an opposing second end of the electrically conductive terminal 407a-407d.

The electrically conductive blades 406a-406d are configured to directly contact a respective wire 304a-304d and establish electrical connection between a respective electrically conductive wire 304a-304d and a respective connector pin 402a-402d. According to a non-limiting embodiment each of the conductive blades 406a-406d includes an opposing pair of prongs 409a-409d spaced apart from one another to define a blade slot 411 configured to receive a wire inserted therein. Accordingly, the prongs 409a-409d can, if necessary pierce the wire insulation layer, and establish physical contact with a respective wire 304a-304d. In one or more non-limiting embodiments, each IDC wafers 404a-404d includes a single blade 406a-406d which establishes an IDC connection with a single wire 304a-304d disposed in the wire organizer 401.

According to a non-limiting embodiment, the plurality of IDC wafers 404a-404d includes a first differential IDC wafer pair and a second differential IDC wafer pair. The first differential IDC wafer pair includes a first IDC wafer 404a configured to contact the first wire 304a and a second IDC wafer 404b configured to contact the second wire 304b. The second differential IDC wafer pair includes a third IDC wafer 404c configured to contact the third wire 304c and a fourth IDC wafer 404d configured to contact the fourth wire 304d. Accordingly, full-symmetry is established between the pairs of differential connector pins (e.g., connector pins 402a and 402b, and 402c and 402d), and in turn full-symmetry is achieved between front contact pair 502a and 502b and front contact pair 502c and 502d.

Each of the first and second IDC wafers 404a and 404b extends from a first end supporting the connector pin 402a and 402b to an opposing second end supporting the electrically conductive blade 406a and 406b to define a first wafer length. Each of the second and third IDC wafers 404c and 404d extends from a first end supporting the connector pin 402c and 402d to an opposing second end supporting the electrically conductive blade 406c and 406d to define a second wafer length. According to a non-limiting embodiment, the second wafer length of the second and third IDC wafers 404c and 404d is greater than the first wafer length of the first and second IDC wafers 404a and 404b.

According to a non-limiting embodiment, the IDC wafers 404a-404d are fabricated according to stamping and over-molding processes. For each individual IDC wafer 404a-404d, the electrically conductive connector pins 402a-402d, the electrically conductive terminals 407a-407d, and the electrically conductive blades 406a-406d are stamped from an electrically conductive material. According to a non-limiting embodiment, the electrically conductive material is metal such as, copper, brass, tin, silver, gold, etc. The stamped connector pin 402a-402d, stamped electrically conductive terminals 407a-407d and stamped electrically conductive blades 406a-406d may be overmolded with a polymer material (e.g., plastic) to form the plurality of IDC wafers 404a-404d. In one or more non-limiting embodiments, the stamped connector pins 402a-402d, stamped electrically conductive terminals 407a-407d, and stamped electrically conductive blades 406a-406d are plated with a metal material prior to performing the overmolding. The plated metal material can include gold, for example, but is should be apricated that other metals can be utilized. A process flow for fabricating the IDC wafers 404a-404d is described in greater detail below.

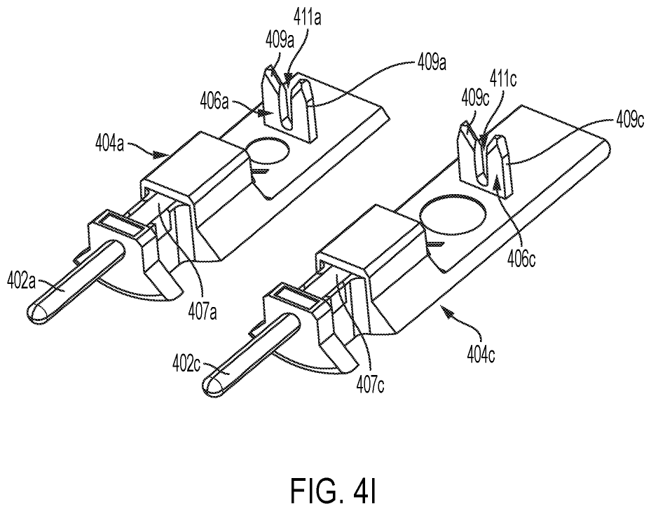

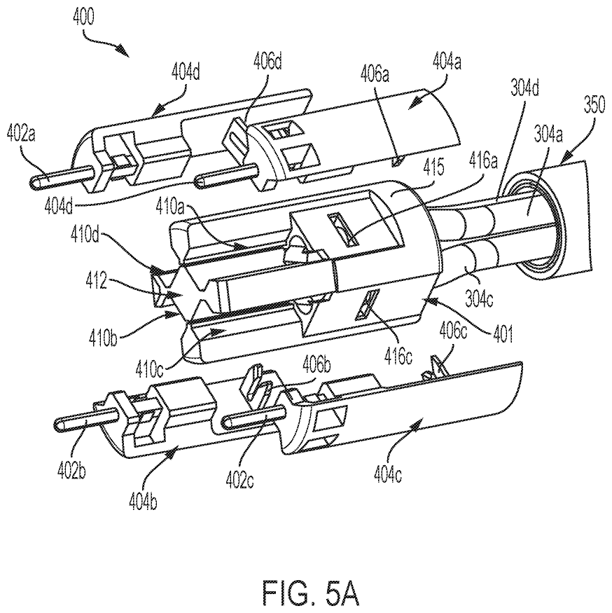

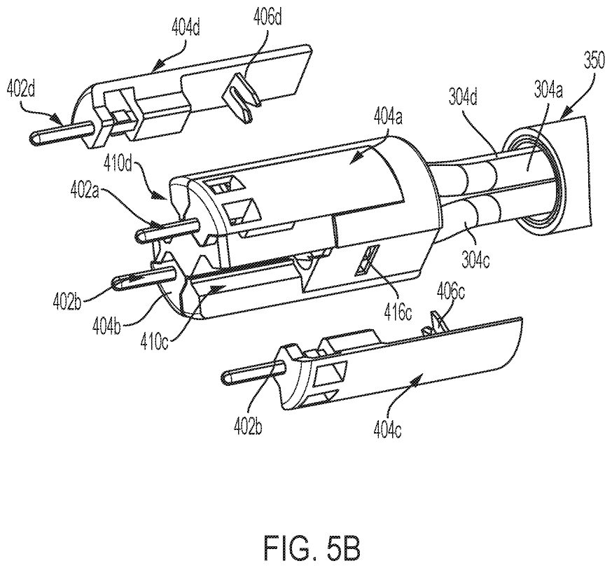

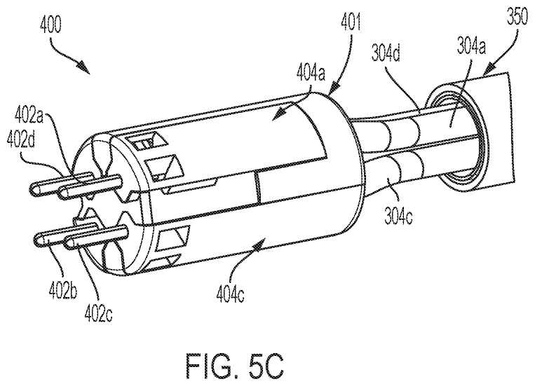

With reference to FIGS. 5A to 5C, a process diagram for assembling a IDC wafer adapter assembly 400 with a plurality of wires 304a-304d is illustrated according to a non-limiting embodiment. At FIG. 5A, a disassembled IDC wafer adapter assembly 400 is provided with a plurality of wires 304a-304d inserted into the wire organizer 401. Accordingly, wires 304a and 304b are arranged into a first differential wire pair arrangement and wires 304c and 304d are arranged into a second differential wire pair arrangement.

Referring to FIG. 5B, the IDC wafer adapter assembly 400 is illustrated following insertion of a first differential IDC wafer pair 404a and 404b into the wire organizer 401 to establish electrical connection with the first differential wire pair 304a and 304b, respectively. Turning to FIG. 5C, the IDC wafer adapter assembly 400 is illustrated following insertion of a second differential IDC wafer pair 404c and 404d into the wire organizer 401 to establish electrical connection with the second differential wire pair 304c and 304d. respectively.

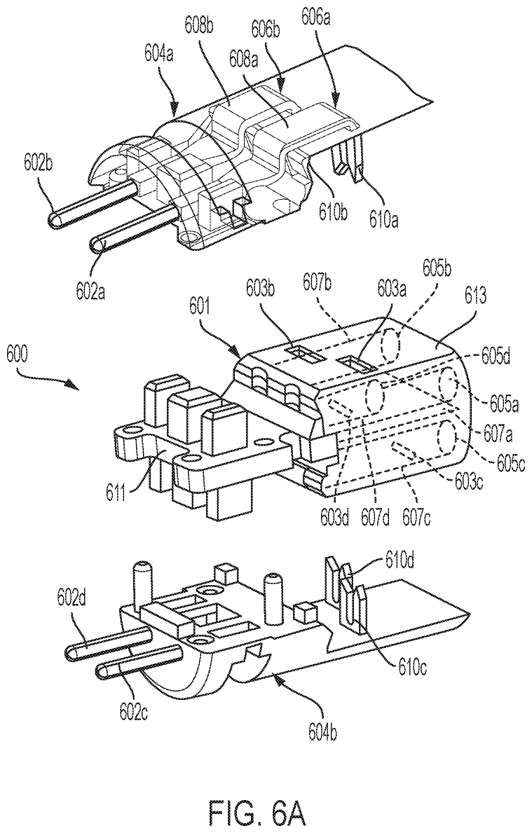

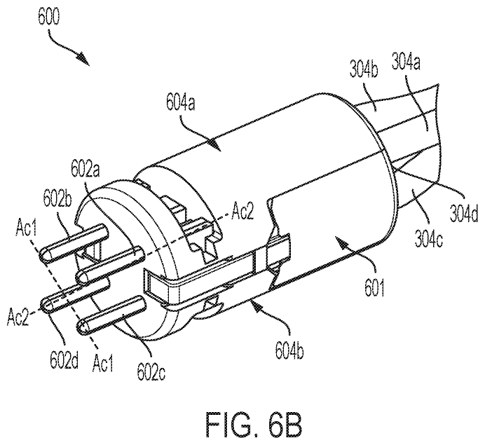

Turning now to FIGS. 6A and 6B, an IDC wafer adapter assembly 600 is illustrated according to another non-limiting embodiment. The IDC wafer adapter assembly 600 includes a wire organizer 601 and a pair of IDC wafers 604a and 604b. The wire organizer 601 extends from a front end 611 to a rear end 613. The wire organizer 601 includes a plurality of wire slots 605a-605d configured to receive the plurality of electrically conductive wires 304a-304d, respectively, and to dispose the wires 304a-304d into respective guide paths 607a-607d. IDC slots 603a-603d formed in the wire organizer 601 provide access to the respective guide paths 607a-607d.

According to a non-limiting embodiment, the wire organizer 601 facilitates disposal the electrically conductive wires 304a-304d into a quadrax arrangement. That is, the wire organizer 601 arranges the wires 304a-304d into a plurality of differential wire pairs. The differential wire pairs include a first differential wire pair including a first wire 304a and an opposing second wire 304d arranged along a first axis Ac1 extending in a first direction, and a second differential wire pair including a third wire 304b and an opposing fourth wire 304c arranged along a second axis Ac2 that extends in a direction opposite the first direction of the first axis Ac1.

The IDC wafers 604a and 604b are implemented as multi-blade IDC wafers. In other words, each IDC water 604a and 604b includes multiple blades configured to establish an IDC connection with a respective wire 304a-304d. Accordingly, the first IDC wafer 604a can establish an IDC connection with a first wire group 304a and 304b among the plurality of electrically conductive wires 304a-304d, and the second IDC wafer can establish an IDC connection with a second wire group 304c and 304d among the plurality of wires 304a-304d.

According to a non-limiting embodiment, the first IDC wafer 604a includes a first IDC connection assembly and a second IDC connection assembly. The first IDC connection assembly includes a first electrically conductive connector pin 602a, a first electrically conductive terminal 608a having a first end coupled to the first electrically conductive connector pin 602a, and a first electrically conductive blade 610a coupled to an opposing second end of the first electrically conductive terminal 608a. The second first IDC connection assembly includes a second electrically conductive connector pin 602b, a second electrically conductive terminal 608b having a first end coupled to the second electrically conductive connector pin 602b, and a second electrically conductive blade 610b coupled to an opposing second end of the second electrically conductive terminal 608b.

The first electrically conductive blade 610a is insertable into the first IDC slot 603a to connect with the first wire 304a and establish electrical connection between the first electrically conductive pin 602a and the first wire 304a. Likewise, the second electrically conductive blade 610b is insertable into the second IDC slot 603b to connect with the second wire 304b and establish electrical connection between the second electrically conductive pin 602b and the second wire 304b.

The second IDC wafer 604b includes a third IDC connection assembly and fourth IDC connection assembly. The third IDC connection assembly includes a third electrically conductive connector pin 602c, a third electrically conductive terminal 608c having a first end coupled to the third electrically conductive connector pin 602c, and a third electrically conductive blade 610c coupled to an opposing second end of the third electrically conductive terminal 608c. The fourth IDC connection assembly includes a fourth electrically conductive connector pin 602d, a fourth electrically conductive terminal 608d having a first end coupled to the second electrically conductive connector pin 602d, and a fourth electrically conductive blade 610d coupled to an opposing second end of the fourth electrically conductive terminal 608d.

The third electrically conductive blade 610c is insertable into the third IDC slot 603c to connect with the third wire 304c and establish electrical connection between the third electrically conductive pin 602c and the third wire 304c. Likewise, the fourth electrically conductive blade 610d is insertable into the fourth IDC slot 603d to connect with the fourth wire 304d and establish electrical connection between the fourth electrically conductive pin 602d and the fourth wire 304d.

According to a non-limiting embodiment, the first blade 610a included on the first IDC wafer 604a and the fourth blade 610d included on the fourth IDC wafer 604d establish a first differential blade pair (e.g., 610a and 610d). Likewise, the second blade 610b included on the second IDC wafer 604b and the third blade 610c included on the third IDC wafer 604c establish a second differential blade pair (e.g., 610b and 610c). Accordingly, each of the blades 610a and 610b on the first IDC wafer 604a and each of the blades 610c and 610d establishes an IDC connection with wires 304a and 304b, respectively, and each of the blades 610c and 610d on the second IDC wafer 604b establishes an IDC connection with wires 304c and 304d, respectively. In this manner, the multi-blade wafers 604a and 604b can establish at least partial symmetry between the pairs of differential connector pins (e.g., connector pins 602a and 602d, and 602b and 602c), and in turn at least partial symmetry can be achieved between front contact pair 502a and 502d, and front contact pair 502b and 502c.

As described herein, one or more non-limiting embodiments of the present disclosure provides a IDC wafer adapter assembly (e.g., IDC wafer adapter assembly 400 or IDC wafer adapter assembly 600), which employs a plurality of individual IDC wafers (e.g., IDC wafers 404a-404d or IDC wafers 604a-604b) to establish an IDC connection with wires 304a-304d disposed in a wire organizer (e.g., wire organizer 401 or wire organizer 601). Each of the IDC wafers includes at least one of a first electrically conductive connector pin (e.g., 402a or 602a), a first electrically conductive terminal (e.g., 407a or 608a) having a first end coupled to the first electrically conductive connector pin, and a first electrically conductive blade (e.g., 406a or 610a) coupled to an opposing second end of the first electrically conductive terminal.

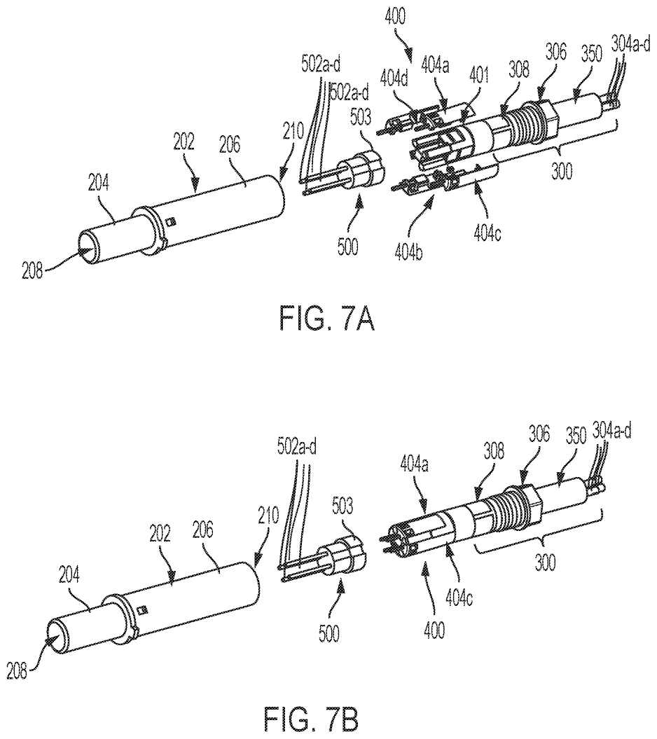

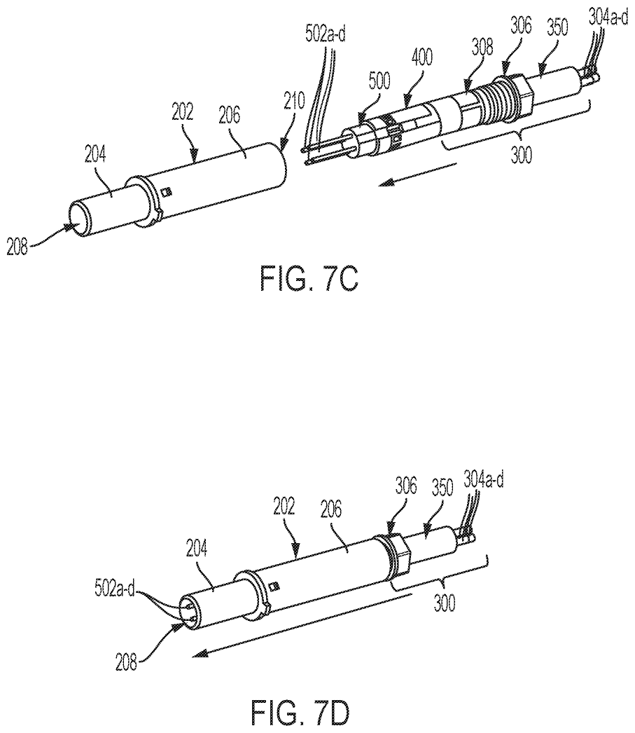

With reference to FIGS. 7A to 7D, a process diagram for assembling the electrical cable assembly shown in FIG. 1A is illustrated according to a non-limiting embodiment of the present disclosure. At FIG. 7A, the electrical cable assembly 100 is depicted after coupling the tail end assembly 300 to the wire organizer 401.

Turning to FIG. 7B, the electrical cable assembly 100 is depicted following insertion of the IDC wafers 404a-404d in the wire organizer 401 to establish electrical connection with a plurality of wires 304a-304d. According to a non-limiting embodiment, a first differential IDC wafer pair 404a and 404b establishes IDC connections with a first pair of wires 304a and 304b, respectively, and a second differential IDC wafer pair 404c and 404d establishes IDC connections with a second pair of wires 304c and 304d, respectively.

Turning to FIG. 7C, the electrical cable assembly 100 is depicted after coupling the assembled IDC wafer adapter assembly 400 to the front contact assembly 500. The rear portion 503 of the front contact assembly 500 receives the connector pins 402a-402d of the IDC wafer adapter assembly 400 so that each connector pin 402a-402d physically contacts a respective contact 502a-502d. Accordingly, the front contact assembly 500 establishes electrical conductivity between the connector pins 402a-402d and the plurality of contacts 502a-502d.

Referring to FIG. 7D, the electrical cable assembly 100 is depicted after inserting the assembled IDC wafer adapter assembly 400 into a connector housing 202 and coupling the connector housing 202 to the tail end assembly 300. As described herein, the cable interface end 206 of the cable housing 202 includes connector threads formed on an inner surface thereof, which are configured to mate with threads formed on the coupling assembly 301 (e.g., the outer surface of the bushing 306). In this manner, the connector housing 202 can be screwed (e.g., coupled) and unscrewed (decoupled) from the tail end assembly 300 to provide a serviceability feature not provided by conventional electrical cable assemblies. As described herein, other techniques can be implemented to coupling/decoupling mechanism including, but not limited to, press fitting together connector housing 202 and the tail end assembly 300, a clip and hook assembly that fastens and unfastens connector housing 202 and the tail end assembly 300, etc.

The serviceability provided by the electrical connector assembly 100 includes facilitating replacement of the front contact assembly 500. For example, a method of servicing the electrical cable assembly 100 includes decoupling the connector housing 202 from a tail end assembly 300 so as to removing the IDC wafer adapter assembly 400 coupled to the tail end assembly and the front contact assembly 500 from within the connector housing 202. Thereafter, the method includes removing the front contact assembly 500 from the IDC wafer adapter assembly 400, coupling another front contact assembly 500 to the IDC wafer adapter assembly 400. The newly coupled front contact assembly 500 can include the same type of front contact assembly 500 that excludes one or more damaged portions, or can include a different type of front contact assembly 500. The method then includes inserting the newly coupled front contact assembly 500 and the IDC wafer adapter assembly 400 into the connector housing 202, coupling the electrical connector housing 202 to the tail end assembly 300.

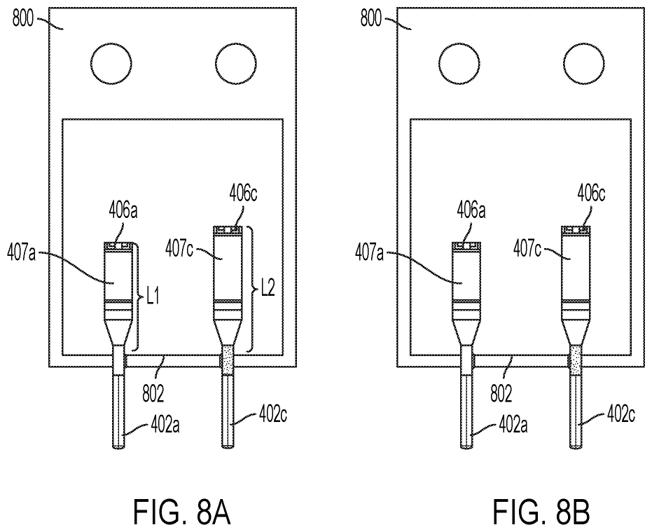

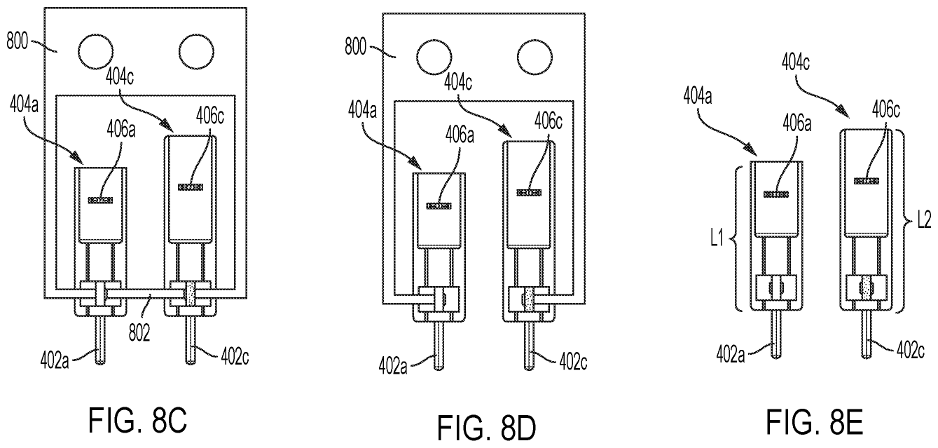

Turning now to FIGS. 8A to 8D, process diagram for fabricating a pair of IDC wafers 404a and 404c is illustrated according to a non-limiting embodiment. With reference to FIG. 8A, a pair of electrical terminals 404a and 404c are shown after being stamped from a metal sheet 800. The metal sheet 800 can be formed from any known metal material. A first terminal 404a includes a first end coupled to a contact 402a and an opposing second end coupled to a blade 406a. Likewise, second terminal 407c includes a first end coupled to a contact 402c and an opposing second end coupled to a blade 406c. According to a non-limiting embodiment shown in FIGS. 8C-8E, the first terminal 404a can be formed having a first length (L1) and the second terminal 404c can be formed having a second length (L2) that is greater than the first length (L1) of the first terminal 404a.

Turning to FIG. 8B, the contacts 402a and 402c following a metal plating process. According to a non-limiting embodiment, a metal material such as gold, for example, can be applied according to various application processing including but not limited to dipping the contacts 402a and 402c in a liquid metal, spraying a metal material onto the contacts 402a and 402c, etc. Although FIG. 8B illustrates applying the metal to only the contacts 402a and 402c, it should be appreciated that the metal can also be applied to the terminals 407a and 407c, and/or the blades 406a and 406c without departing from the scope of the invention.

Referring to FIG. 8C, the terminals 407a and 407c are shown following an over-molding process to form a pair of IDC wafers 404a and 404c. In a non-limiting embodiment, the over-molding process can include over-molding the terminals 407a and 407c with a plastic or polymer material. Each of the IDC wafers 404a and 404c include a wafer body extending along a first direction to define a wafer length, a second direction orthogonal to the first direction to define a wafer width, and a third direction orthogonal to the first and second directions to define a wafer thickness.

Turning to FIG. 8D, the IDC wafers 404a and 404c are shown after cutting the carrier strip 802 to separate a first IDC wafer 404a from a second IDC wafer 404c.

Accordingly, a pair of IDC wafers 404a and 404c are provided as shown in FIG. 8E.

According to a non-limiting embodiment, a first IDC wafer 404a (e.g., a short IDC wafer) can be formed having a first length (L1) and a second IDC wafer 404c (e.g., a long IDC wafer) can be formed having a second length (L2) greater than the first length (L1) of the first wafer 404a. In this manner, a first differential pair of short IDC wafers can be formed (e.g., 404a and 404b) and a second differential pair of long wafers can be formed (e.g., 404c and 404d) as shown in FIG. 4D.

Although FIGS. 8A-8E illustrate fabrication of single wafer with a single IDC connection assembly (e.g., a single blade), it should be appreciated that the fabrication process described in FIGS. 8A-8E can be applied to fabricate a single wafer, multi-IDC connection assembly (e.g., a single wafer, multi-blade wafer) as shown in FIGS. 6A-6B without departing from the scope of the invention.

As described herein, various non-limiting embodiments of the present disclosure provide an electrical cable assembly that implements an IDC connection. The cable assembly may include an electrical connector, a IDC wafer adapter assembly, and a tail end assembly. The IDC wafer adapter assembly may utilize a wire organizer that places a plurality of wires bundled in the tail end assembly into a quadrax arrangement that provides symmetry (e.g., full-symmetry) between the differential contact pairs of the quadrax arrangement. The wire organizer may also receive a plurality of individual IDC wafers having IDC contacts configured to establish the IDC connection with a respective wire. The electrical connector may further be detachably coupled to the IDC wafer adapter assembly and the tail end. In this manner, the entire electrical cable assemble does not require replacement should one or more of the contacts be damaged.

The teachings described herein may be implemented as an apparatus and/or a method at any possible technical detail level of integration. Aspects of the disclosure are described herein with reference to flowchart illustrations and/or block diagrams of one or more methods. In some alternative implementations, the functions noted in the blocks may occur out of the order noted in the Figures. For example, two blocks shown in succession may, in fact, be performed substantially concurrently, or the blocks may sometimes be performed in the reverse order.

The descriptions of the various embodiments have been presented for purposes of illustration, but are not intended to be exhaustive or limited to the embodiments described.

Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. An electrical cable assembly comprising:
a cable comprising electrically conductive wires;
a connector housing defining an internal area, the connector housing having a mating interface end defining a mating interface opening and a cable interface end defining a cable interface opening;
an insulation displacement contact (IDC) wafer adapter assembly disposed in the internal area of the connector housing, the IDC wafer adapter assembly organizing the electrically conductive wires into a quadrax arrangement; and
a plurality of IDC wafers disposed in the IDC wafer adapter assembly, the IDC wafers being configured to establish IDC connections with the electrically conductive wires, a number of the IDC connections matching a number of the IDC wafers.

2. The electrical cable assembly of claim 1, further comprising, a tail end assembly configured to detachably couple to the electrical connector.

3. The electrical cable assembly of claim 1, wherein the electrically conductive wires of the electrical cable comprise a first differential wire pair and a second differential wire pair, wherein the IDC wafer adapter assembly disposes on a first axis the first differential wire pair with a first wire and a second wire, and wherein the IDC wafer adapter assembly disposes on a second axis the second differential wire pair with a third wire and an opposing fourth wire, wherein the first axis is perpendicular to the second axis.

4. The electrical cable assembly of claim 3, further including a front connector detachably coupled to the IDC wafer adapter assembly, the front connector including a plurality of front contacts extending through the hollow internal area of the connector housing and being exposed via the mating interface opening.

5. The electrical cable assembly of claim 4, wherein the plurality of IDC wafers each include an IDC connection assembly that establishes a physical IDC connection with an electrically conductive wire of the electrically conductive wires.

6. The electrical cable assembly of claim 5, wherein the IDC connection assembly includes:
an electrically conductive connector pin;
an electrically conductive terminal having a first end coupled to the connector pin: and
an electrically conductive blade coupled to an opposing second end of the electrically conductive terminal, the electrically conductive blade directly contacting an electrically conductive wire of the electrically conductive wires.

7. The electrical cable assembly of claim 6, wherein at least one of the electrically conductive connector pin, the electrically conductive terminals, and the electrically conductive blade is stamped from an electrically conductive material.

8. The electrical cable assembly of claim 7, wherein at least one of the electrically conductive connector pin, the electrically conductive terminals, and the electrically conductive blade is overmolded with a polymer material.

9. The electrical cable assembly of claim 3, wherein the plurality of IDC wafers includes:
a first pair of IDC wafers including a first IDC wafer establishing a first IDC connection with the first wire and a second IDC wafer establishing a second IDC connection with the second wire; and
a second pair of IDC wafers including a third IDC wafer establishing a third IDC connection with the third wire and a fourth IDC wafer establishing an IDC connection with the fourth wire.

10. The electrical cable assembly of claim 9, wherein the wire organizer includes a plurality of guide trenches that each receive one of the plurality of electrically conducive wires and are spaced apart from one another to define a plurality of wafer spaces that each receive one of the plurality of IDC wafers.

11. The electrical cable assembly of claim 10, further comprising a plurality of braces, wherein each wafer space of the plurality of wafer spaces includes a brace of the plurality of braces, and wherein each of the plurality of braces includes an IDC slot that receives the electrically conductive blades.

12. The electrical cable assembly of claim 11, wherein the plurality of braces includes:
a first pair of braces including with a first brace disposed in the first wafer space and a second brace disposed in the second wafer space; and
a second pair of braces including a third brace disposed in the third wafer space and a fourth brace disposed in the fourth wafer space.

13. The electrical cable assembly of claim 12, wherein the electrically conductive blade of the first IDC wafer is disposed in the IDC slot of the first brace, the electrically conductive blade of the second IDC wafer is disposed in the IDC slot of the second brace, the electrically conductive blade of the third IDC wafer is disposed in the IDC slot of the third brace, and the electrically conductive blade of the fourth IDC wafer is disposed in the IDC slot of the fourth brace.

14. The electrical cable assembly of claim 1, further including a coupling assembly that couples together the electrical cable and the IDC wafer adapter assembly.

15. The electrical cable assembly of claim 14, wherein the coupling assembly includes a first mating portion coupled to the electrical cable and a second mating portion coupled to the IDC wafer adapter assembly.

16. The electrical cable assembly of claim 15, wherein the first mating portion includes a bushing coupled to the cable, and wherein the second mating portion includes a ferrule assembly coupled to the bushing and the connector housing.

17. The electrical cable assembly of claim 16, wherein the bushing includes a bushing body having bushing threads formed thereon, and wherein an inner surface of the connector housing has connector threads that mate with bushing threads to couple together the connector housing and the tail end assembly.

18. The electrical cable assembly of claim 17, wherein the ferrule assembly includes:
a rear ferrule coupled to the bushing; and
a front ferrule coupled to the rear ferrule and the IDC wafer adapter assembly.

19. A quadrax insulation displacement contact (IDC) wafer adapter assembly comprising:
a plurality of IDC wafers, each of the IDC wafers including an electrically conductive IDC connection assembly configured to establish an IDC connection with an electrically conductive wire among a plurality of electrically conductive wires; and
a wire organizer extending along a center axis to define an assembly length, the wire organizer configured to receive a plurality of wires and to receive the plurality of IDC wafers such that IDC connection assembly of the IDC wafers physically contact the plurality of wires respectively to establish a full-symmetry connection.

20. The quadrax IDC wafer adapter assembly of claim 19, wherein the wire organizer disposes the electrically conductive wires into a quadrax arrangement which includes a plurality of differential wire pairs, and wherein the full-symmetry connection is established among the differential wire pairs such that contacts included with the conductive IDC connection assembly are arranged in a differential pair that are equidistant from center axis, extending through the wire organizer, throughout the entire assembly length.

21. The quadrax IDC wafer adapter assembly of claim 20, wherein the plurality of differential wire pairs includes:
a first differential wire pair with a first wire and a second wire arranged along a first axis; and
a second differential wire pair with a third wire and a fourth wire arranged along a second axis, wherein the second axis is perpendicular to the first axis.

22. The quadrax IDC wafer adapter assembly of claim 21, wherein the electrically conductive IDC connection assembly includes:
an electrically conductive connector pin;
an electrically conductive terminal having a first end coupled to the connector pin; and
an electrically conductive blade coupled to an opposing second end of the electrically conductive terminal, the electrically conductive blade being configured to directly contact a respective wire of the plurality of electrically conductive wires and establish electrical connection between the electrically conductive wire and the connector pin.

23. A method of manufacturing an electrical cable assembly, the method comprising:
inserting electrically conductive wires of a cable into a wire organizer that defines an internal area such that the electrically conductive wires are organized into a quadrax arrangement;
disposing a plurality of insulation displacement contact (IDC) wafers in the internal area of the wire organizer to provide a IDC wafer adapter that establishes IDC connections with the electrically conductive wires, wherein a number of the IDC connections match a number of the IDC wafers;
inserting the IDC wafer adapter into an internal area of a connector housing; and
coupling the connector housing to the cable.

24. The method of claim 23, wherein organizing the electrically conductive wires into the quadrax arrangement includes disposing on a first axis a first differential wire pair and disposing on a second axis a second differential wire pair, the second axis being perpendicular with respect to the first axis.

25. The method of claim 24, wherein coupling the connector housing to the cable comprises:
detachably coupling a first end of the IDC wafer adapter to a front contact assembly;
coupling a first end of a coupling assembly to a second end of the IDC wafer adapter and coupling a second end of the coupling assembly to the cable; and
detachably coupling the connector housing to the coupling assembly.

26. The method of claim 25, wherein the front contact assembly includes a plurality of electrically conductive front contacts, and wherein coupling the front contact assembly to the IDC wafer adapter establishes electrical conductivity between the electrically conductive front contacts and the electrically conductive wires.
